(19) United States
(12) Patent Application Publication
(10) Pub. No.: US 2004/0028904 A1
(43) Pub. Date: Feb. 12, 2004

(54) Ultra-light insulation material composition with nonflammability and thermal resistance characteristic, apparatus for manufacturing the same, and method for manufacturing the same by using the apparatus

(76) Inventor: Jong-Won Park, Kyeongsangnam-do (KR)

Correspondence Address: Mark M Friedman, Bill Polkinghorn, Discovery Dispatch, 9003 Florin Way, Upper Marlboro, MD, 20772, US

(21) Appl. No.: 10/250,748

(22) PCT Filed: Dec. 24, 2001
(86) PCT No.: PCT/KR01/02257

(30) Foreign Application Priority Data
Jan. 9, 2001 (KR) 2001/1201

(51) Int. Cl. B32B 5/16

(52) U.S. Cl. 428/402

(57) ABSTRACT

Disclosed are an ultra-light insulation material composition with superior flame-retardant and thermal resistance characteristic, an apparatus for manufacturing the composition, and a method for manufacturing the composition by using the apparatus. A flame-retardant layer including inorganic nonflammable material is formed on a surface of a chip, which is obtained by pulverizing expended polystyrene resin in a size below 3 mm. Through compress-kneading and pressing works with adding thickener, flame-retardant, curing control agent, auxiliary adhesive, dyes/pigments, and waterproofing stuff. The insulation material composition is subject to a pressing work including a vibration pressing work, a press pressing work, and an extrusion pressing work, so that the ultra-light composition can be rapidly obtained. Waste resource is reused and a tire and poisonous gas caused by the insulation material can be prevented. The composition makes a great contribution for solving a pollution problem and disposable polystyrene can be reused.

### TECHNICAL FIELD

The present invention relates to an ultra-light insulation material composition with superior flame-retardant and thermal resistance characteristic, an apparatus for manufacturing the same, and a method for manufacturing the same by using the apparatus, in which the composition is obtained by pressing a flame-retardant layer formed on a surface of a chip through pulverizing expended polystyrene or waste expended polystyrene in a size below 3 mm, thereby maximizing the amount of used chips, and in which additives having flame-retardant, curing control, adhesive assisting, and water-proofing features are added when forming the flame-retardant layer so that the composition has an ultra-light weight with a proper strength.

### BACKGROUND ART

Various kinds of insulation materials are used for preventing the joss of a thermal energy in a human life and industrial fields.

Generally, petrochemical matters having a plurality of pores therein are used for the insulation material. That is, the insulation material is made of organic chemistry matters, such as foam urethane and expended polystyrene, for providing the ultra-light weight and thermal-insulation features. However, organic chemistry matters lack the thermal-resistance characteristic, so they are easily deformed or fired when making contact with a heat or a flame. When a fire breaks out, organic chemistry matters generate poisonous gases, thereby causing a fatal damage to the human. On the other hand, glass wool or asbestos is used as flame-retardant insulation material. Glass wool or asbestos is formed in a cotton yarn shape by melting glass or an ore. However, phenol is coated on a surface of glass wool or asbestos. Phenol is a pollutant causing lung cancer to the human body, so the use of glass wool or asbestos is restricted. However, there is no substitute for phenol in view of economic efficiency and constructability, so phenol is inevitably used for the insulation material where the flame-retardant characteristic is required.

Since expended polystyrene has an ultra-light weight with a superior economic efficiency, it is widely used as the insulation material up to now. For those reasons, expended polystyrene is adapted for wrapping dampers, insulation construction materials having an ultra-light weight, and various containers. In addition, the use of expended polystyrene is gradually increased. However, though expended polystyrene is advantageously used due to its ultra-light weight, the ultra-light weight of expended polystyrene may cause a serious problem. That is, expended polystyrene occupies a large space when wasting it after using. In addition, expended polystyrene is rarely decomposed in a natural state, so the disposal of waste expended polystyrene causes environmental problems.

In order to treat waste expended polystyrene, reclamation, incineration, RDF (refuse derived fuel), and retrieving/recycling treatments are used. However, the reclamation treatment may cause the secondary pollution and require a reclaimed land. In addition, the incineration treatment may generate a great quantity of poisonous gas components, such as dioxin.

Various methods for applying expended polystyrene to slurries of plaster or Portland cement by pulverizing expended polystyrene are well known. However, the amount of expended polystyrene applied to the slurries of conventional cement is limited.

To solve above problem, Korean Patent Application Nos. 10-1997-24873, 10-1996-52445, and 10-1999-53323 disclose a method for manufacturing a relatively secure aggregate having a lightweight by pulverizing and coating expended polystyrene after cutting and melting expended polystyrene. In addition, Korean Patent Application No. 1992-17819 discloses a method for semi-solidifying cement to be used. On the other hand, Korean Patent Application Nos. 1997-24727 and 1987-3207, U.S. Pat. Nos. 5,034,160, 4,751,024, 4,993,884, 5,340,612, and 5,401,538 and Japanese Patent laid-open publication 4-228461 disclose sprayable cement-based fire-proofing compositions with filling pulverized polystyrene grains in cement slurries. However, according to the above publications, the dry blend of expended polystyrene grains is below 5 weight percent of the compositions. In addition, Korean Patent Application Nos. 86-6417 and 93-14715 disclose compositions, in which the amount of expended polystyrene filled in slurries is below 5 weight percent. In this case, the amount of expended polystyrene is below 1 weight percent as compared with a total weight of hydraulic cement added with water. Accordingly, they are not adapted for ultra-light compositions and such compositions are limited in use and application.

Therefore, there is required an ultra-light insulation material composition capable of maximizing the use of expended polystyrene chips with reducing the use of cement as well as improving the flame-retardant characteristic.

### DISCLOSURE OF THE INVENTION

The present invention has been made to solve the above problems of the related art, therefore, it-is an object of the present invention to provide an ultra-light insulation material composition with superior flame-retardant and thermal resistance characteristic, in which an amount of used chips, which are obtained by pulverizing expended polystyrene or waste expended polystyrene in a size below 3 mm, is above 1 weight percent of a total weight including water, so that the composition has an ultra-light weight with improving the fire-proofing and flame-retardant characteristic by enhancing a bonding force of the composition through adding additives.

Another object of the present invention is to provide an ultra-light insulation material composition with superior flame-retardant and thermal resistance characteristic, which is obtained by not only spraying the insulation material composition onto an insulation structure, but also pressing the insulation material composition to achieve the ultra-light insulation material composition.

Still another object of the present invention is to provide an apparatus including various pulverizing devices and a pressing kneader for manufacturing an ultra-light insulation material composition with superior flame-retardant and thermal resistance characteristic, and a method for manufacturing the same by using the apparatus.

To achieve the above objects, an ultra-light insulation material composition having superior flame-retardant and thermal resistance characteristic according to the present invention comprises 1-30 weight percent of expended polystyrene chips which are pulverized in a size below 3 mm, 10-30 weight percent of inorganic nonflammable material, 30-80 weight percent of water, 0.5-7 weight percent of thickener for allowing components to be easily mixed and for enhancing a viscosity, 3-10 weight percent of flame-retardant, and 0-15 weight percent of an auxiliary adhesive for enhancing an adhesive force.

In addition, an apparatus for manufacturing an ultra-light insulation material composition having superior flame-retardant and thermal resistance characteristic according to the present invention comprises a first pulverizing means for pulverizing expended polystyrene chips, a second pulverizing means for secondarily pulverizing expended polystyrene chips pulverized by the first pulverizing means, a collecting means for collecting chips pulverized by the second pulverizing means and having an air blower for injecting high-pressurized air to rapidly discharge the collected chips, a plurality of storing means connected to the collecting means through conduits for transferring the chips, a compress-kneading means for kneading chips supplied from the storing means with inorganic nonflammable material, thickener, flame-retardant, auxiliary adhesive and additives, and a pressing device receiving a mixture from the compress-kneading means and vibrating, pressing or extruding the mixture to complete the composition.

In addition, a method for manufacturing an ultra-light insulation material composition having superior flame-retardant and thermal resistance characteristic according to the present invention comprises the steps of inputting expended polystyrene chips into a first pulverizing means and primarily pulverizing the expended polystyrene chips therein, secondarily pulverizing the expended polystyrene chips in a second pulverizing means having an upper and lower conveyers, collecting the pulverized expended polystyrene chips and discharging the pulverized expended polystyrene chips into a storing means by using an air blower, feeding the chips having a uniform powder state from the storing means into a compress-kneading means through a screw feeder, uniformly kneading the expended polystyrene chips with inorganic nonflammable material, thickener, flame-retardant, auxiliary adhesive and additives in the compress-kneading means, pressing a mixture supplied from the compress-kneading means by accommodating the mixture in a pressing device, thereby manufacturing a complete article.

### BRIEF DESCRIPTION OF THE DRAWINGS

The above objects, and other features and advantages of the present invention will become more apparent by describing preferred embodiments thereof with reference to the attached drawings in which:

FIG. 1 is a view showing an apparatus for manufacturing an ultra-light insulation material composition with superior flame-retardant and thermal resistance characteristic according to one embodiment of the present invention;

FIG. 2 is a perspective view showing a kneader and a pressing device for manufacturing an ultra-light insulation material composition with superior flame-retardant and thermal resistance characteristic according to one embodiment of the present invention;

FIG. 3 is a perspective view showing a pressing device and an article obtained by using the pressing device.

### BEST MODE FOR CARRYING OUT THE INVENTION

Hereinafter, an ultra-light insulation material composition with superior flame-retardant and thermal resistance characteristic, an apparatus for manufacturing the composition, and a method for manufacturing the composition by using the apparatus according to a preferred embodiment of the present invention will be described in detail with reference to the accompanying drawings.

The ultra-light insulation material composition having superior flame-retardant and thermal resistance characteristic according to the present invention includes 1-30 weight percent of chips obtained by pulverizing expended polystyrene or waste expended polystyrene in a size below 3 mm, 10-30 weight percent of inorganic nonflammable material including at least one selected from the group consisting of cement, clay, plaster, waste plaster, and lime, 10-80 weight percent of water, 0.5-7 weight percent of thickener including methyl cellulous, starch, bentonite, and cellulous fiber for enhancing a viscosity when mixing components, 3-10 weight percent of flame-retardant including boric acid and borax, 0-10 weight percent of curing control agent for promoting a curing and including potassium sulfate, aluminum sulfate, magnesium sulfate, magnesium chloride, alum, triethanolamine, plaster, sodium aluminate, sodium silicate, and potassium silicate, 0.0-15 weight percent of an auxiliary adhesive for enhancing an adhesive force and including urea, melamine, epoxy, urethane, carbolic acid, gelatin, and Arabic gum, and 0-15 weight percent of waterproofing stuff for enhancing a water-proof characteristic and including Portland cement waterproofing stuff and plaster waterproofing stuff.

The reason for pulverizing expended polystyrene or waste expended polystyrene in a size below 3 mm is that, if the polystyrene chip has a size above 3 mm, the ultra-light insulation material is easily melted, shrunken or fired when it is exposed to a fire or heat, so the ultra-light insulation material does not act as a fireproofing insulation material. On the contrary, if the polystyrene chip has a size below 3 mm, each grain of the polystyrene chip has a small surface area for receiving the fire or heat, and a flame-retardant layer sufficiently surrounds a periphery portion of the polystyrene chip, so the ultra-light insulation material effectively performs the function of the fireproofing insulation material.

In addition, urethane foam pulverizing chip, pearlite, or vermiculite can be mixed with the expended polystyrene chip depending on the usage thereof.

The composition having the above components is processed through a compress-kneader and a pressing device so as to be manufactured as an article. The article includes a great amount of expended polystyrene, as possible, to have the ultra-light weight with maintaining proper strength and superior flame-retardant characteristic. Such article can be achieved only through compress-kneading and pressing techniques, which will be described below. In order to manufacture the composition of the present invention, an apparatus for manufacturing the composition of the present invention is inevitably required.

The kneading process is preferably carried out with using a compression technique. In addition, though the chip and inorganic nonflammable material hardening under water can be independently used, it is preferred to add thickener and auxiliary adhesive for increasing an early adhesive force. In this case, it is possible to knead a great amount of chips, so that the ultra-light weight is achieved and the strength thereof is enhanced. When the flame-retardant layer is formed with using inorganic nonflammable material, such as alumina oxide, borax, clay, and chlorinated paraffin, instead of inorganic nonflammable material hardening under water, it is preferred to add the auxiliary adhesive, such as epoxy and melamine to obtain a desired article. By adding flame-retardant agent, the heat-proofing characteristic is improved, so that the fire and resident flame can be prevented. In addition, by adding curing control agent, the composition can be rapidly obtained. Waterproofing stuff, such as Portland cement waterproofing stuff or plaster waterproofing stuff, and dyes/pigments are used for allowing the composition to have various colors with maintaining waterproof and endurance characteristic.

When kneading the ultra-light flame-retardant composition, inorganic nonflammable material and additives are mixed with pulverized chips with adding water. However, it is preferred that after making the chips in a wet state by spraying the additives diluted with water into the pulverized chips, inorganic nonflammable material is kneaded with the chips.

In addition, when the composition is manufactured in an atmospheric pressure state, the endurance of the composition is lowered. For this reason, the composition is preferably manufactured by using vibration, pressing and extruding processes with applying a pressure above 20 kg/cut. Preferably, a vibration-pressing process is used for improving the strength of the composition and flatting a surface of the composition.

At this time, the composition can be obtained within 3 hours by adopting the curing control agent. The composition has an improved waterproof characteristic due to the waterproofing stuff. In addition, by finishing the surface of the composition with thermosetting resin, paint, ion plate, or cotton yarn depending on the usage thereof, a high quality composition can be achieved.

Hereinafter, the component construction and action of the ultra-light insulation material composition with superior flame-retardant and thermal resistance characteristic will be described in detail.

Pulverized Expended Polystyrene Chip

Chips used in the present invention are obtained by pulverizing expended polystyrene (a high-polymer article, such as waste expended polystyrene or organic urethane foam, having pores therein and including one group which is adhered to inorganic nonflammable material and adhesive and another group such as foamed ore pearlite and vermiculite). Generally, the grain size of the chips is in a range of 3 to 0.1 mm. If the grain size is above 3 mm, the composition cannot be easily kneaded or mixed due to the flexibility of the grain. In this case, the composition can be easily melted or fired when exposed to the fire or heat, thereby lowering the fireproofing characteristic of the composition. If the grain size is below 0.1 mm, the chips are easily dispersed, so it is difficult to treat the chips. In this case, a great amount of inorganic nonflammable material is required, so that the specific gravity and insulation characteristic are lowered.

On the other hand, in order to further reduce the weight of the composition, beads (foamed spherical grain) can be mixed with the chips within a ratio of 5 weight percent. By filling the beads having various colors, the composition has an excellent interior appearance. In addition, if heat in the temperature about 150° C. is applied to the surface of the composition, the beads are easily melted and a plurality of grooves are formed on the surface of the composition, so the composition can be used as a sound-absorbing composition.

Inorganic Nonflammable Material

A main function of inorganic nonflammable material used in the present invention is to allow the composition to have heatproof or fireproof characteristic by forming a flame-retardant layer on the surface of the pulverized chip. It is preferred for the inorganic nonflammable material to have a predetermined adhesive force so as to be adhered to adjacent chips. Nonflammable materials having a fine inorganic powder phase, such as alumina oxide, magnesia oxide, and titanium oxide, which are fireproofing materials, can be used together with the auxiliary adhesive depending on the usage thereof.

Preferably, the inorganic nonflammable material is at least one selected from the group consisting of cement, clay, plaster, waste plaster, lime, diatomite, magnesia oxide, alumina oxide, and titanium oxide, which are fine powders above 200 mesh and have the above-mentioned function. The cement includes Portland cement, alumina cement, silica cement, magnesia cement, phosphate cement, and silicate cement. In addition, the inorganic nonflammable material can be made by mixing at least one of the above components.

Thickener

When adding water to the inorganic nonflammable material and polystyrene chip, the inorganic nonflammable material is easily coated on surfaces of plural chips, thereby forming the minute flame-retardant layer. In order to facilitate the mixing of the additives, 0.5-7 weight percent of methyl cellulous, starch, bentonite, or cellulous fiber is added. At this time, if the amount of the thickener to be added exceeds a predetermined level, the curing can be delayed. For this reason, it is important to add a proper amount of the thickener while controlling the curing state by using curing control agent.

Flame-Retardant

Flame-retardant of the present invention penetrates into the flame-retardant layer when the inorganic nonflammable material forms the flame-retardant layer on the surface of the chip so as to improve the quality of the flame-retardant layer. Accordingly, the fireproofing characteristic of the polystyrene chip is further improved, so the polystyrene chip is prevented from being fired or deformed when making contact with the fire or heat. The flame-retardant includes boric acid, borax, phosphoric acid, ammonium phosphate, incineration material, bentonite, or chlorinated paraffin. According to the preferred embodiment of the present invention, 3-10 weight percent of boric acid and phosphoric acid having a predetermined viscous force and an auxiliary adhesive function are added for manufacturing the composition. Therefore, the composition has the auxiliary adhesive function while maintaining the safety with respect to the fire and heat.

Curing Control Agent

Curing control agent is added for rapidly manufacturing the ultra-light insulation material composition with flame-retardant and thermal resistance characteristic. The curing control agent is divided into a curing accelerator and a curing retarder. Generally, the curing is promoted by adding the curing accelerator. However, the curing retarder can be used in the inorganic nonflammable materials, such as plaster or lime, which is rapidly cured. The curing accelerator includes a mixture having at least one selected from the group consisting of potassium sulfate, aluminum sulfate, magnesium sulfate, magnesium chloride, alum, triethanolamine, plaster, sodium-aluminate, sodium silicate, and potassium silicate, silicate or a mixture of sodium silicate and modified acryl resin, and CO₂ gas. The curing retarder includes ethylene glycol. The sort and amount of the curing control agent to be added is varied depending on the sorts of the inorganic nonflammable materials.

Auxiliary Adhesive

As the amount of expended polystyrene chips increases or the inorganic nonflammable material, which is not hardening under water, is used, the boding force between chips in the composition is remarkably lowered. Therefore, there is required to enhance the adhesive force between the chips: In order to reinforce the adhesive force of the composition, 0-15 weight percent of auxiliary adhesive can be added. The auxiliary adhesive includes at least one of urea, melamine, epoxy, urethane, carbolic acid, gelatin, and Arabic gum.

Waterproofing Stuff

Since the inorganic nonflammable material is shallowly coated on the surface of the ultra-light insulation material composition having superior flame-retardant and thermal resistance characteristic, the waterproofing feature thereof may be lowered. To improve the waterproofing feature of the composition, at least one of Portland cement waterproofing stuff, plaster waterproofing stuff, acryl, vinyl-acetate, melamine, epoxy, and urethane is added to the composition.

Additives

The ultra-light insulation material composition having superior flame-retardant and thermal resistance characteristic according to the present invention can be colored with various colors by adding dyes and pigments when the composition is used for an interior decorating purpose. Preferably, inorganic pigments are used instead of organic pigments so as to improve the thermal resistance characteristic.

Hereinafter, a preferred embodiment of the ultra-light insulation material composition having superior flame-retardant and thermal resistance characteristic will be described in detail by comparing with a standard insulation material.

Embodiment 1

In this embodiment, plaster is used as the inorganic nonflammable material.

A test sample including 6 weight percent of expended polystyrene chip pulverized in a size below 3 mm, 25 weight percent of plaster, 60 weight percent of water, 1.7 weight percent of methyl cellulous, 2.4 weight percent of aluminum sulfate, 2.6 weight percent of boric acid, 2 weight percent of melamine, and 0.3 weight percent of titanium oxide is kneaded in a compressing kneader. Then, the test sample is subject to a vibration pressing process in a pressing device, so that the ultra-light insulation material composition with superior flame-retardant and thermal resistance characteristic is obtained. Properties of the ultra-light insulation material composition are tested and the result is shown in table 1.

The ultra-light insulation material composition is tested based on a KS (Korean Standards) L 9106 of a board type thermal insulation material made of rock wool.

TABLE 1

| | | | Result | | |
|---|---|---|---|---|---|
| Test items | | | Embodiment 1 | Reference | Test method |
| Flame-retardant | Surface test | Melt, harmful | No | No | KS F 2271-98 |
| Characteristic | | deformation | | | |
| (2^{nd} grade) | | Crack (mm) | 0 | 30 | |
| | | Flame remain time | 0 | 30 | |
| | | (sec) | | | |
| | | Fuming coefficient | 6.0 | 60 | |

| | | | |
|---|---|---|---|
| Temp, | Within | 28.8 | Below 100 |
| time, | 3 min | | |
| area | After | 2.5 | Below 100 |
| | 3 min | | |

| | Noxious gas test | Passed | Passed | |
|---|---|---|---|---|
| Compression strength (kgf/cm²) | | 3.7 | — | KS M 3861-97 (test |
| | | | | speed 1 mm/min) |
| Bending strength (kgf/cm²) | | 2.6 | — | KS L 5207-99 (test |
| | | | | speed 1 mm/min) |
| Density (kg/m³) | | 176 | Below 500 | KS L 9016-95 |
| Thermal | Mean temperature 70° C. | 0.37 | Above 0.35 | |
| conductivity | | | | |
| (kcal/m.h. ° C.) | | | | |

As shown in table 1, the ultra-light insulation material composition of the present invention represents superior flame-retardant and thermal resistance characteristic as compared with those of conventional expended polystyrene. The test result represents that the composition of the present invention is superior to the board type thermal insulation material made of rock wool. The present invention uses 1-30 weight percent of expended polystyrene chips, thereby allowing the composition to have the ultra-light weight with superior thermal insulation and thermal resistance characteristic. Therefore, a thermal insulation article made of the composition according to the present invention has an ultra-light weight and superior physical properties including the strength.

As mentioned above, the cement used as the inorganic nonflammable material preferably includes material hardening under water, such as Portland cement, alumina cement, magnesia cement, phosphate cement, silicate cement, plaster and lime. Besides those inorganic nonflammable materials, when a nonflammable layer is formed by using nonflammable powders having fine grains above 200 meshes, the auxiliary adhesive is added, so that the ultra-light insulation material composition having superior flame-retardant and thermal resistance characteristic can be obtained.

The composition kneaded through the compress-kneading process is manufactured as a completed thermal insulation article through vibration, pressing, and extruding processes. If necessary, dyes and pigments are added to allow the composition to have various colors. In addition, it is possible to treat the surface of the composition by using thermosetting resin, a heatproof film, and an iron plate depending on the usage thereof, in order to increase the thermal-resistance characteristic of the composition. Furthermore, since the flame-retardant layer is formed on the surface of the composition after the kneading process is carried out, the thermal resistance of the composition is improved so that the composition can be used as the thermal insulation material. In addition, the thermal resistance characteristic of the composition can be further improved by re-kneading the composition.

Hereinafter, an apparatus for manufacturing the ultra-light insulation material composition having superior flame-retardant and thermal resistance characteristic and a method for manufacturing the composition by using the apparatus will be described in detail.

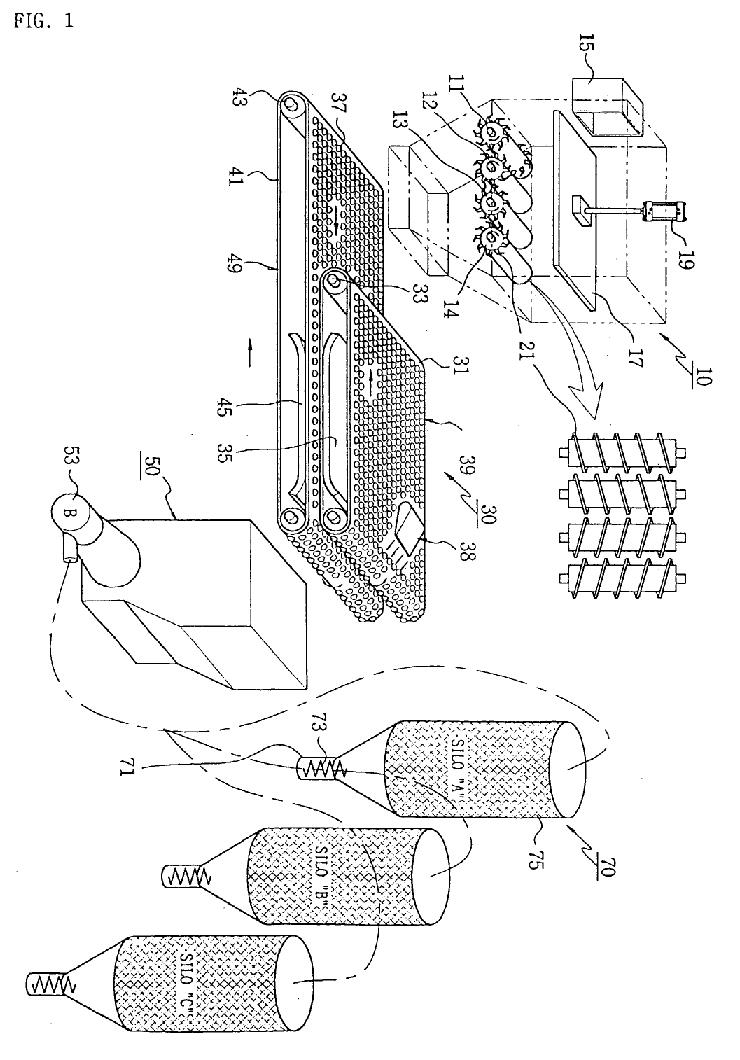

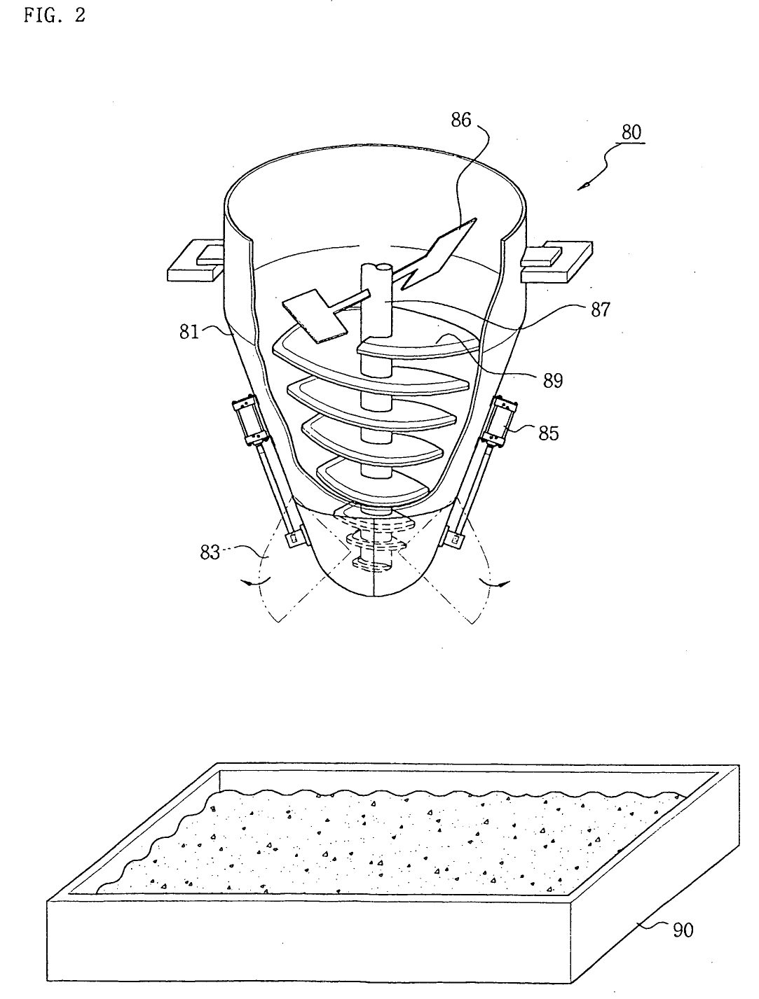

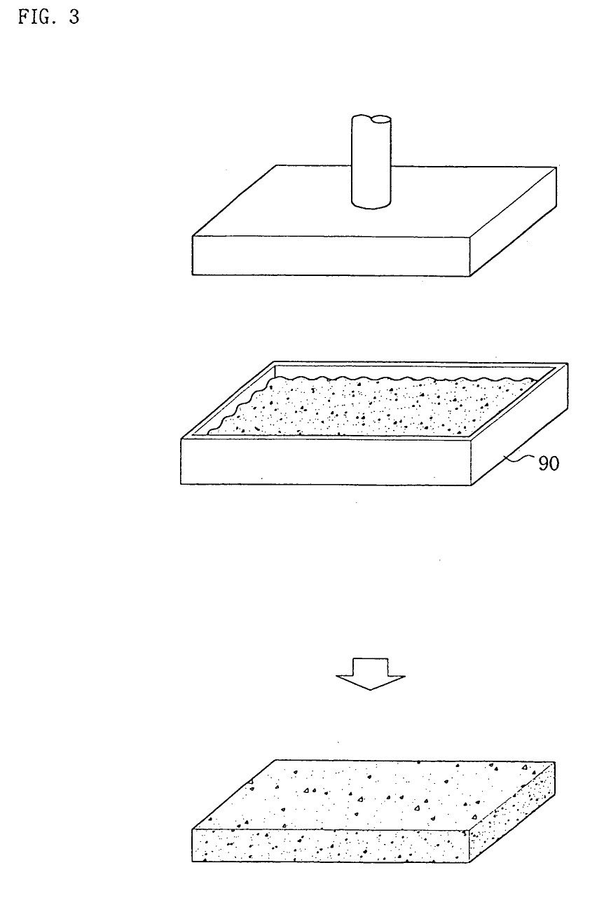

FIG. 1 is a view showing the apparatus for manufacturing the ultra-light insulation material composition having superior flame-retardant and thermal resistance characteristic according to one embodiment of the present invention, FIG. 2 is a perspective view showing a compress-kneader and a pressing device for manufacturing the ultra-light insulation material composition, and FIG. 3 is a perspective view showing a pressing device and an article obtained by using the pressing device.

As shown in FIGS. 1 to 3, the apparatus for manufacturing the ultra-light insulation material composition having superior flame-retardant and thermal resistance characteristic includes a first pulverizing device 10 for pulverizing expended polystyrene chips, a second 13 pulverizing device 30 for secondarily pulverizing expended polystyrene chips pulverized by the first pulverizing device 10, a collecting device 50 for collecting chips pulverized by the second pulverizing device 30 and having an air blower 53 for injecting high-pressurized air to rapidly discharge the collected chips, a plurality of storing devices 70 having a plurality of surface covers connected to the collecting device 50 through conduits (not shown) for transferring the chips and formed at an outer wall thereof with a fine mesh screen, and a compress-kneading device 80 for kneading chips supplied from the storing device 70 with inorganic nonflammable material, thickener, flame-retardant, auxiliary adhesive and additives. In addition, a pressing device 90 is positioned next to the compress-kneading device 80 so as to receive a mixture from the compress-kneading device 80. The pressing device 90 vibrates, presses or extrudes the mixture to manufacture a complete article.

The first pulverizing device 10 is formed at an upper portion thereof with an inlet 15 for inputting expended polystyrene. An outlet 16 for discharging the pulverized polystyrene chips is formed at a lower portion of the first pulverizing device 10. A pressing plate 17, which presses inputted expended polystyrene from an upper portion thereof to effectively pulverize the expended polystyrene, is accommodated in the first pulverizing device 10. A hydraulic cylinder is connected to an upper portion of the pressing plate 17 to reciprocate the pressing plate 17 up and down. In addition, in order to pulverize expended polystyrene into chips, first to fourth pulverizers 11, 12, 13 and 14 are installed below the pressing plate 17 of the first pulverizing device 10. A plurality of blades 21 are integrally formed at a periphery portion of each pulverizers in a spiral pattern. The first and third pulverizers 11 and 13 rotate clockwise, and the second and fourth pulverizers 12 and 14 rotate counterclockwise.

In addition, the second pulverizing device 30 receives the pulverized chips from the first pulverizing device 30 so as to further finely pulverize the pulverized chips. The second pulverizing device 30 includes an upper conveyer 39 and a lower conveyer 49. The upper conveyer 39 has a first consecutive belt 31 formed at a surface thereof with a plurality of protrusions 38 and a pair of first rollers 33 which rotate while supporting both sides of the first consecutive belt 31. In addition, a distance between the upper and lower conveyers 39 and 40 can be adjusted, so that the grain size of the polystyrene chips can be adjusted. A first pushing plate 35 is installed in the first consecutive belt 31 for downwardly pushing the first consecutive belt 31.

The lower conveyer 49 has a second consecutive belt 42 formed at a surface thereof with a plurality of protrusions, and a pair of second rollers 43 which rotate while supporting both sides of the second consecutive belt 41. A second pushing plate 45 is installed in the second consecutive belt 41 for upwardly pushing the second consecutive belt 41. The second consecutive belt 41 is longer than the first consecutive belt 31.

The upper conveyer 31 rotates in a material supplying direction or vice versa, and the lower conveyer 41 rotates in the material supplying direction. In addition, the upper conveyer 31 rotates with a low speed and the lower conveyer 41 rotates with a high speed.

In addition, an air washer 37 is installed at one upper end of the second pulverizing device 30 where the pulverized chips drop into the collecting device 50, so the chips are precisely dropped into the collecting device 50 without passing through the collecting device 50 together with the belt.

The storing device 70 has a surface cover, a body 75 formed with a fine mesh screen, and a discharge port 71 integrally formed with a lower portion of the body 76 for discharging the chips. A screw feeder 73 is installed in the discharge port 71 for allowing the chips to be easily discharged.

In addition, the compress-kneading device 80 includes a housing 81 for kneading the pulverized chips with inorganic nonflammable material, thickener, flame-retardant, curing control agent, auxiliary adhesive and additives and a gate 83 which is opened and closed at a lower portion of the housing. A pneumatic cylinder 85 is installed in the hosing 81 to open/close the gate 83. A rotating shaft 87 rotated by an external power source (not shown) is installed in the housing 81. A screw 89 is spirally and continuously formed along a peripheral portion of the rotating shaft 87 so as to effectively knead the mixtures. The spiral screw 89 is rotated by the external power source in such a manner that the mixtures are conveyed into a lower end of the housing 81 while being compress-kneaded, and the kneaded mixtures are conveyed into an upper portion of the housing 81 along the inner wall of the housing 81 caused by a pressure applied thereto. Since the mixtures are continuously conveyed from the upper portion to the lower portion of the housing 81 or vice versa, the mixtures are accurately mixed. In addition, a dispersing prevention device 86 is integrally formed at an upper end of the rotating shaft 87 for downwardly compressing the pulverized chips. The dispersing prevention device 86 rotates together with the rotating shaft 87.

According to another embodiment of the present invention, the second pulverizing device is construed in a roller type, instead of the conveyer type. For example, the second pulverizing device includes a pair of rollers formed at periphery portions thereof with blade type protrusions. The expended polystyrene chips pass through between the rollers so that the expended polystyrene chips are scratched.

Hereinafter, the apparatus for manufacturing the ultra-light insulation material composition having superior flame-retardant and thermal resistance characteristic according tore present invention operates as follows.

Firstly, expended polystyrene or waste expended polystyrene is inputted through the inlet 15 of the first pulverizing device 10. Then, inputted polystyrene is compressed by the compressing plate 17 through a hydraulic cylinder 19, and the roll pulverizers 11, 12, 13, and 14 rotate so that expended polystyrene is pulverized. At this time, the first and third roll pulverizers 11 and 13 rotate clockwise, and the second and fourth roll pulverizers 12 and 14 rotate counterclockwise, so expended polystyrene passing through between the first and third roll pulverizers 11 and 13 and between the second and fourth roll pulverizers 12 and 14 can be pulverized into chips by blades 21 spirally installed along peripheries of the roll pulverizers 11, 12, 13 and 14.

On the other hand, it is preferred that the surface of the pulverized chip having a size below 3 mm is roughly formed to easily and stably attach the inorganic nonflammable material thereto. Though it is not shown in figures, a rotating pulverizer (roller type) having a plurality of blades, such as saw blades, can be provided for roughly forming the surface of the pulverized chip. The rotating pulverizer scratches the surface of expended polystyrene when expended polystyrene passes therethrough.

The pulverized polystyrene chips drop into the lower conveyer 49 of the second pulverizing device 30 through the outlet 16. Then, the chips move in the right direction caused by the rotation of the lower conveyer 39. The moving chips pass through between upper and lower conveyers 39 and 49, so the chips are further pulverized. At the same time, a waffle pattern is formed on the chips by the protrusions 38 formed on the surfaces of the upper and lower conveyers 39 and 49. At this time, due to the first and second pushing plates 35 and 45, the waffle pattern is effectively formed and the chips are effectively pulverized.

In addition, since the upper conveyer 39 rotates at a lower speed and the lower conveyer 40 rotates at a high speed, the pulverizing operation for the polystyrene chips are effectively carried out. The grain size of the chips can be adjusted by adjusting the distance between upper and lower conveyers 39 and 49.

The pulverized chips are collected in the collecting device 50 guided by the air washer 37, and the collected chips are conveyed into the storing devices 70 through the air blower 53.

The chips conveyed into the storing devices 70 are pulverized into a powder state and supplied into the compress-kneading device 80 through the screw feeder 73 installed in the discharge port 71.

The compress-kneading device 80 kneads the expended polystyrene chips with components forming the composition of the present invention, such as inorganic nonflammable material. At this time, mixtures accommodated in the compress-kneading device 80 are mixed caused by the rotation of the rotating shaft 87. The mixtures are downwardly moved by the screw 89 formed at the periphery of the rotating shaft 87 in a spiral pattern. Then, the mixtures upwardly move along the inner wall of the housing 81. In addition, the dispersing prevention device 86 rotates to downwardly compress the pulverized chips to be dispersed. The compress-kneading device 80 repeats the above operation, so that the mixtures are uniformed mixed.

When the mixtures have been completed, the gate 83 is automatically opened by the pneumatic cylinder 85 installed in the housing 81. Then, the mixtures are filled in the pressing device 90. The mixtures are subject to the vibration, pressing, or extrusion process in the pressing device 90 and are cured after a predetermined time lapses. As a result, the ultra-light thermal insulation article having flame-retardant and thermal resistance characteristic can be obtained.

According to the above apparatus and method, the article can be easily manufactured by pressing the mixtures after injecting the mixtures into the pressing device. In addition, the weight and surface state of the article can be adjusted by adjusting the amount of the inorganic nonflammable material to be added. When it is required to further reduce the weight of the article, spherical expended polystyrene beads are added. Therefore, the article can be used as an interior or exterior decorating member of a construction having a lightweight, a fireproofing member for a safe, a panel, a fireproofing door, and a wall member of a ship. That is, the article can be adapted for various industrial fields and human life as a fireproofing insulation material. In addition, it is possible to finish the surface of the article with phenol resin, melamine, unsaturated polyester, acryl, paint, an iron plate, cotton yarn or a film to achieve an excellent outer appearance. On the other hand, the grain of the chip formed at the surface thereof with the inorganic nonflammable material represents high thermal resistance characteristic, so the grain itself can be used as the ultra-light thermal insulation material having flame-retardant characteristic, without forming the article.

In addition, depending on the usage thereof, a mesh shaped shim can be accommodated in the article or attached to the surface of the article when manufacturing the article.

Further, the article can be variously formed depending on the usage thereof. That is, the article can be formed in a curvature shape or in a waffle pattern. In addition, various kinds of pores can be formed in the article.

On the other hand, the thermal insulation material composition can be reused through re-pulverizing the composition into a various grains. In addition, the composition can be used as an aggregate of cement concrete or as a filler of PVC and a stuff of sound absorbing thermal insulation member formed on granule.

While the present invention has been described in detail with reference to the preferred embodiment thereof, it should be understood to those skilled in the art that various changes, substitutions and alterations can be made hereto without departing from the scope of the invention as defined by the appended claims.

### INDUSTRIAL APPLICABILITY

As described above, the ultra-light insulation material composition with superior flame-retardant and thermal resistance characteristic according to the present invention is obtained by adding the inorganic nonflammable material, thickener, flame-retardant, curing control agent, auxiliary adhesive, waterproofing stuff and additives to the expended polystyrene chips, in which an irregular waffle pattern is formed on the surface of the grain thereof while being pulverized in a size below 3 mm, so the flame-retardant layer is formed on each surface of the grain of the chips. Accordingly, the composition cannot be easily deformed or damaged when exposed to the fire or heat. In addition, the composition cannot be fired or spreads the flame even in the high temperature above 850° C., so the fire and noxious gas caused by the thermal insulation material can be prevented. Further, the composition of the present invention can be used as a sound absorbing or a sound shielding insulation material depending on the usage thereof.

In addition, the apparatus and method of the present invention can manufacture the ultra-light insulation material composition having superior flame-retardant and thermal resistance characteristic. The composition obtained by the apparatus and method of the present invention can be replaced with a thermal insulation material made from rock wool, which causes a pollution problems. In an environmental view, the present invention has an advantage that waste expended polystyrene causing the environmental problems can be reused.

1. An ultra-light insulation material composition with superior flame-retardant and thermal resistance characteristic, the composition comprising:
1-30 weight percent of expended polystyrene chips which are pulverized in a size below 3 mm;
10-30 weight percent of inorganic nonflammable material;
30-80 weight percent of water; 0.5-7 weight percent of thickener for allowing components to be easily mixed and for enhancing a viscosity;
3-10 weight percent of flame-retardant; and
0-15 weight percent of an auxiliary adhesive for enhancing an adhesive force.

2. The composition as claimed in claim 1, wherein the inorganic nonflammable material is a mixture including at least one selected from the group consisting of cement, clay, plaster, waste plaster, lime, diatomite, magnesia oxide, alumina oxide, and titanium oxide.

3. The composition as claimed in claim 2, wherein the cement is at least one selected from the group consisting of Portland cement, alumina cement, silica cement, magnesia cement, phosphate cement, and silicate cement.

4. The composition as claimed in claim 1, wherein the thickener is at least one selected from the group consisting of methyl cellulous, starch, bentonite, and cellulous fiber.

5. The composition as claimed in claim 1, wherein the flame-retardant is at least one selected from the group consisting of boric acid, borax, phosphoric acid, ammonium phosphate, incineration material, bentonite, and chlorinated paraffin.

6. The composition as claimed in claim 1, wherein the auxiliary adhesive is at least one selected from the group consisting of urea, melamine, epoxy, urethane, carbolic acid, gelatin, and Arabic gum.

7. The composition as claimed in claim 1, further comprising 0-10 weight percent of curing control agent for promoting a curing.

8. The composition as claimed in claim 7, wherein the curing control agent is at least one selected from the group consisting of potassium sulfate, aluminum sulfate, magnesium sulfate, magnesium chloride, alum, triethanolamine, plaster, sodium aluminate, sodium silicate, and potassium silicate.

9. The composition as claimed in claim 1, further comprising a waterproofing stuff for enhancing a water-proof characteristic.

10. The composition as claimed in claim 9, wherein the waterproofing stuff is at least one selected from the group consisting of Portland cement waterproofing stuff, plaster waterproofing stuff, acryl, vinyl-acetate, melamine, epoxy, and urethane.

11. The composition as claimed in claim 1, wherein further comprising dyes and pigments for providing colors.

12. An ultra-light insulation material composition with superior flame-retardant and thermal resistance characteristic for forming an ultra-light insulation structure by forming flame-retardant and nonflammable layers on a surface of pulverized expended polystyrene chip, the composition comprising:
1-30 weight percent of expended polystyrene chips which are pulverized in a size below 3 mm;
10-30 weight percent of inorganic nonflammable material;
30-80 weight percent of water; 0.5-7 weight percent of thickener for allowing components to be easily mixed and for enhancing a viscosity;
3-10 weight percent of flame-retardant;
0-10 weight percent of curing control agent; and
0-15 weight percent of an auxiliary adhesive for enhancing an adhesive force, wherein the composition is mixed in a compress-kneading technique and pressed by applying a pressure.

13. An apparatus for manufacturing an ultra-light insulation material composition having superior flame-retardant and thermal resistance characteristic, the apparatus comprising:
a first pulverizing means for pulverizing expended polystyrene chips;
a second pulverizing means for secondarily pulverizing expended polystyrene chips pulverized by the first pulverizing means;
a collecting means for collecting chips pulverized by the second pulverizing means, the collecting means having an air blower for injecting high-pressurized air to rapidly discharge the collected chips;
a plurality of storing means connected to the collecting means through conduits for transferring the chips;
a compress-kneading means for kneading chips supplied from the storing means with inorganic nonflammable material, thickener, flame-retardant, auxiliary adhesive and additives; and
a pressing device receiving a mixture from the compress-kneading means and vibrating, pressing or extruding the mixture to manufacture a complete article.

14. The apparatus as claimed in claim 13, wherein the first pulverizing means includes;
an inlet for inputting expended polystyrene;
a pressing plate for pressing inputted expended polystyrene from an upper portion thereof;
a hydraulic cylinder connected to the pressing plate to reciprocate the pressing plate up and down;
a plurality of roll pulverizers formed at peripheral portions thereof with a plurality of blades, which are formed in a spiral pattern for pulverizing expended polystyrene; and
an outlet for discharging expended polystyrene chips which pass through the roll pulverizers.

15. The apparatus as claimed in claim 13, wherein the second pulverizing means includes;
an upper conveyer having a first consecutive belt formed at a surface thereof with a plurality of protrusions, a pair of first rollers which rotate while supporting both sides of the first consecutive belt, and a first pushing plate installed in the first consecutive belt for downwardly pushing the first consecutive belt; and
a lower conveyer having a second consecutive belt which is longer than the first consecutive belt and formed at a surface thereof with a plurality of protrusions, a pair of second rollers which rotate while supporting both sides of the second consecutive belt, and a second pushing plate installed in the second consecutive belt for upwardly pushing the second consecutive belt.

16. The apparatus as claimed in claim 13, wherein the second pulverizing means includes a pair or rollers formed at peripheral portions thereof with blade-type protrusions, such as saw blades.

17. The apparatus as claimed in claim 13, wherein each storing means includes:
a body having a surface cover and formed with a fine mesh screen;
a discharge port integrally formed with a lower portion of the body for discharging the chips; and
a screw feeder installed in the discharge port for discharging the chips.

18. The apparatus as claimed in claim 13, wherein the compress-kneading means includes;
a housing for kneading the pulverized chips with inorganic nonflammable material and additives;
a rotating member installed in the housing;
a screw spirally and continuously formed along a peripheral portion of the rotating member;
a dispersing prevention device integrally formed at an upper end of the rotating member for preventing pulverized chips from being dispersed;
a gate installed at a lower portion of the housing so as to be opened or closed; and
a pneumatic cylinder connected to the gate for opening/closing the gate.

19. A method for manufacturing an ultra-light insulation material composition having superior flame-retardant and thermal resistance characteristic, the method comprising the steps of:
i) inputting expended polystyrene chips into a first pulverizing means and primarily pulverizing the expended polystyrene chips therein;
ii) secondarily pulverizing the expended polystyrene chips in a second pulverizing means having an upper and lower conveyers;
iii) collecting the pulverized expended polystyrene chips and discharging the pulverized expended polystyrene chips into a storing means by using an air blower;
iv) feeding the chips having a uniform powder state from the storing means into a compress-kneading means through a screw feeder;
v) uniformly kneading the expended polystyrene chips with inorganic nonflammable material, thickener, flame-retardant, auxiliary adhesive and additives in the compress-kneading means;
vi) pressing a mixture supplied from the compress-kneading means by accommodating the mixture in a pressing device, thereby manufacturing a complete article.

20. The method as claimed in claim 19, wherein, in step ii), a speed of the lower conveyer is higher than a speed of the upper conveyer.

21. The method as claimed in claim 19 or 20, wherein step ii) includes a step of scratching surfaces of the pulverized expended polystyrene chips having a size below 3 mm by allowing the chips to pass through between rotating pulverizers having a plurality of blade-type protrusions, such as saw blades, for roughly forming the surfaces of the pulverized chips.

22. The method as claimed in claim 21, wherein, in step vi), the pressing work includes a vibration pressing work, a press pressing work, and an extrusion pressing work.

23. The method as claimed in claim 21, wherein, in step vi), the pressing work includes a vibration pressing work, a press pressing work, and an extrusion pressing work.

24. The method as claimed in claim 22, wherein, in step vi), the pressing work includes a vibration pressing work, a press pressing work, and an extrusion pressing work.
